(19) United States
(12) Patent Application Publication
(10) Pub. No.: US 2003/0183468 A1
(43) Pub. Date: Oct. 2, 2003

(54) Device for supplying energy to rail vehicles

(76) Inventors: Christian Stitz, Erlangen (DE); Lutz Wegenke, Dueren (DE)

Correspondence Address: HARNESS, DICKEY & PIERCE, P.L.C., P.O.BOX 8910, RESTON, VA, 20195, US

(21) Appl. No.: 10/311,745

(22) PCT Filed: May 30, 2001
(86) PCT No.: PCT/DE01/02047

(51) Int. Cl. B60L 1/00

(52) U.S. Cl. 191/2

(57) ABSTRACT

The invention relates to a device for supplying electrical energy to rail vehicles. An alternating-current supply (1) is thus connected to a rectifier (3a ). A connection (4) for a rail vehicle is arranged after the rectifier (3a). Several rectifiers (3) are arranged in parallel to the one rectifier (3a). A connection (4) for a rail vehicle is arranged after each rectifier (3, 3a). The rectifiers (3, 3a) are, for example, individually controllable.

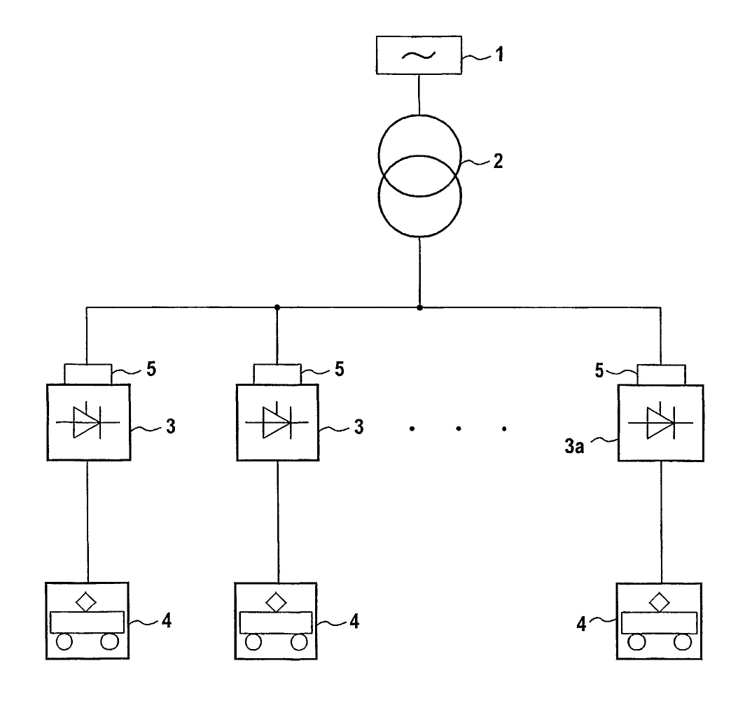

The invention relates to a device for supplying rail vehicles with electrical power, having an AC voltage source to which a rectifier is connected, with the rectifier being followed by a connection for a rail vehicle.

In a depot, for example, electrical power is required in the rail vehicles parked there, for maintenance and repair work. Normally, this power can be supplied to the vehicle from the outside. A specific external depot supply is required even for an electrically powered vehicle, for example an electric locomotive or ICE train, in order to allow maintenance work to be carried out on the drive systems as well, for example on the motor, which would otherwise always have to be connected to the overhead wire.

A previously normal device for the supply in a depot comprises an AC voltage source. If necessary, a transformer is connected to this AC voltage source, which is followed in series by a regulated rectifier. This rectifier is normally followed by an apparatus for DC distribution, for example a busbar with a number of outgoers. One rail vehicle may be connected to each of these outgoers.

Direct current is thus fed into the rail vehicle. The vehicle itself has a converter which converts the direct current into alternating current or 3-phase power, as is required for operating appliances, tools or the like during maintenance or repair. Such a converter may be an inverter.

The previously normal device for supplying power in the depot required (in order to avoid reactions from a rail vehicle on the rectifier) the use of contactors, charging resistors and reaction inductors, since the instantaneous power requirements of a number of rail vehicles being supplied at the same time in the depot is generally different.

The invention is based on the object of specifying a device for supplying power to rail vehicles, which are generally stationary, which in a simple and reliable manner ensures a supply which is matched particularly well to the individual rail vehicles.

According to the invention, the object is achieved in that a number of rectifiers are arranged in parallel with the one rectifier, and in that each rectifier is followed by in each case one connection for only one rail vehicle.

This results in the advantage that each vehicle has its own associated rectifier, so that there is no need for contactors, charging resistors and reaction inductors. Despite this simplified hardware design of the device, reactions on the rectifiers do not occur, even if, at a specific point in time the rail vehicles which are, for example, parked in the depot, have a different power requirement.

Although a number of rectifiers are required instead of one rectifier, the device is financially viable owing to the lack of expensive contactors, resistors and inductors. Furthermore, in operation, the device according to the invention is considerably more reliable than previous devices.

By way of example, the rectifiers can be regulated individually. This results in the particular advantage that each rail vehicle can be supplied individually.

By way of example, the DC voltage can be regulated up and/or down in the form of a ramp by the rectifiers. This means that it is virtually impossible for the converters, for example the inverters, which are located in the rail vehicles and the rectifiers to influence one another.

By way of example, the AC voltage source is followed by a transformer for reducing the voltage (conversion from high voltage to low voltage).

An exemplary embodiment of the device according to the invention will be explained in more detail with reference to the drawing:

The drawing shows an AC voltage source 1. This AC voltage source 1 is followed by a transformer 2, which converts the applied voltage to an AC voltage which can be dimensioned as appropriate. The converted AC voltage is supplied to a number of rectifiers 3, 3a which are arranged in parallel and of which, for simplicity, only three are illustrated. Each of these rectifiers 3, 3a can be regulated separately and for this purpose contains a regulator 5. The DC voltage which is emitted by the rectifiers 3, 3a may be regulated up or down in the form of a ramp. Furthermore, since each rectifier 3, 3a can be regulated individually, the electrical power emitted from it can be adjusted as required.

Each of the rectifiers 3, 3a is followed by a connection 4 to which, if required, the internal power supply of a rail vehicle can be connected. It is thus possible to provide each rail vehicle with the respectively required amount of power using simple means, without having to take any precautions against the electrical systems of the rail vehicle having any effect on the supply device.

Each rail vehicle has converters, which convert the DC voltage to the AC voltage which is required there.

The use of the rectifiers 3, 3a allows particularly simple regulation of the power supply for rail vehicles externally, for example in a depot.

1. A device for supplying rail vehicles with electrical power, having an AC voltage source (1) to which a rectifier (3) is connected, with the rectifier (3a) being followed by a connection (4) for a rail vehicle,
characterized in that a number of rectifiers (3) are arranged in parallel with the one rectifier (3a), and in that each rectifier (3, 3a) is in each case followed by one connection (4) for only one rail vehicle.

2. The device as claimed in claim 1,
characterized in that the rectifiers (3, 3a) can be regulated individually.

3. The device as claimed in claim 2,
characterized in that the DC voltage can be regulated up and/or down in the form of a ramp by the rectifiers (3, 3a).
